(19) United States
(12) Patent Application Publication
(10) Pub. No.: US 2015/0004572 A1
(43) Pub. Date: Jan. 1, 2015

(54) Real-Time Operation-Based Onboard Coaching System

(71) Applicant: Caterpillar Inc., Peoria, IL (US)

(72) Inventors: Bradley K. Bomer, Perkin, IL (US); Zhijun Cai, Springfield, IL (US); Brad Van De Veer, Washington, IL (US); Jeffrey Stephen Alig, Metamora, IL (US); Rohan Raosaheb Chougule, Peoria, IL (US)

(21) Appl. No.: 13/927,331

(22) Filed: Jun. 26, 2013

(51) Int. Cl. G09B 5/02; G09B 19/16

(52) U.S. Cl. CPC G09B 5/02; G09B 19/167
USPC 434/219

(57) ABSTRACT

A method for coaching an operator of an earthmoving machine is disclosed. The machine may have a controller in communication with a plurality of sensors configured to generate actual data indicative of real-time parameters associated with an operation of the machine. In this aspect, the method comprises the controller receiving actual data related to the operation of the machine performed by the operator. The controller determines a type of operation being performed based on the actual data. The controller compares the actual data to expected data for the type of operation being performed as preprogrammed in a memory associated with the controller. The controller provides notification of performance to the operator in real-time based on the comparison of the actual data to expected data.

### FIELD OF THE DISCLOSURE

The present disclosure relates generally to earthmoving machines and, more particularly, to systems and methods for coaching an operator of an earthmoving machine to perform an operation.

### BACKGROUND OF THE DISCLOSURE

Machines used in earthmoving, industrial and agricultural applications require considerable skill to operate. Such machines include, but are not limited to, wheel loaders, tract-type tractors, motor graders, excavators, articulated trucks, pipe layers, backhoes, and the like. Operators of such machines must generally undergo extensive training in order to understand how to safely and efficiently operate the machine.

In addition, each machine may have an ideal or expected method of operation. The ideal method of operation may, for example, be designed to enable efficient or optimal performance of the machine. However, for a variety of reasons, an operator may deviate from the ideal operating method while using the machine. For example, the operator may have limited skills, may encounter an unusual and/or challenging work environment, or may simply be fatigued. In any event, such a failure to follow the expected operating method may lower machine performance, reduce fuel efficiency, or cause other undesirable effects.

One attempted solution has been to create a system which generates a simulated environment of a worksite. For example, U.S. Pat. No. 8,139,108, entitled “Simulation System Implementing Real-Time Machine Data” and assigned to Caterpillar Inc., describes such a system. The system of the '108 patent describes a simulation system that uses real-time performance data to remotely simulate operation of a machine at a worksite. Once a controller of the system of the '108 patent generates a simulated 3-D environment of the worksite, the operator can control and move the machine about the worksite.

The present disclosure is directed to a system to improve operator skill levels. However, it should be appreciated that the solution of any particular problem is not a limitation on the scope of this disclosure or of the attached claims except to the extent expressly noted. Additionally, this background section discusses observations made by the inventors; the inclusion of any observation in this section is not an indication that the observation represents known prior art except that the contents of the indicated patent represent a publication. With respect to the identified patent, the foregoing summary thereof is not intended to alter or supplement the prior art document itself; any discrepancy or difference should be resolved by reference to the document itself.

### SUMMARY OF THE DISCLOSURE

In accordance with one aspect of the present disclosure, a method is provided for coaching an operator of an earthmoving machine having a controller in communication with a plurality of sensors configured to generate actual data indicative of real-time parameters associated with an operation of the machine. In this aspect, the method comprises the controller receiving actual data related to the operation of the machine performed by the operator. The controller determines a type of operation being performed based on the actual data. The controller compares the actual data to expected data for the type of operation being performed as preprogrammed in a memory associated with the controller. The controller provides notification of performance to the operator in real-time based on the comparison of the actual data to expected data.

In accordance with another aspect of the present disclosure, a system is provided for coaching an operator of an earthmoving machine. In accordance with this aspect, the system comprises a plurality of sensors configured to generate signals indicative of actual data associated with an operation of the machine performed by the operator. The system further comprises a controller in communication with the plurality of sensors. The controller is configured to receive the signals indicative of actual data associated with the operation, compare the actual data to expected data preprogrammed into a memory associated with the controller, and notify the operator of his performance in real-time based on the comparison of the actual data to the expected data. The system further comprises an output device in communication with the controller. The output device is configured to output notification from the controller of operator performance in real-time.

In accordance with yet another aspect of the present disclosure, a non-transitory computer-readable medium is provided having stored thereon computer-executable instructions which when executed by a computer cause the coaching of an operator of a machine. The computer-executable instructions comprise, in this aspect, instructions for monitoring an operation of the machine performed by the operator, instructions for determining a type of operation being performed, instructions for comparing actual data from the operation in real-time to expected data for the determined type of operation, and instructions for generating feedback to the operator in real-time of his performance based on the comparison of the actual data to expected data.

These and other aspects and features will become more readily apparent upon reading the following detailed description when taken in conjunction with the accompanying drawings.

Although various features are disclosed in relation to specific exemplary embodiments, it is understood that the various features may be combined with each other, or used alone, with any of the various exemplary embodiments without departing from the scope of the disclosure.

### BRIEF DESCRIPTION OF THE DRAWINGS

FIG. 1 is a perspective view of a machine according to an example embodiment of the present disclosure;

FIG. 2 is a perspective view of another machine according to another example embodiment of the present disclosure;

FIG. 3 is a perspective view of another machine according to another example embodiment of the present disclosure;

FIG. 4 is a perspective view of another machine according to another example embodiment of the present disclosure;

FIG. 5 is a block diagram of a system for coaching an operator according to another embodiment of the present disclosure;

FIG. 6 is a schematic view of a display of the system for coaching an operator of FIG. 5, according to another embodiment of the present disclosure;

FIG. 7 is a block diagram of a system for coaching an operator according to another embodiment of the present disclosure; and

FIG. 8 is a flowchart illustrating a method for coaching an operator of a machine according to another embodiment of the present disclosure.

While the present disclosure is susceptible to various modifications and alternative constructions, certain illustrative embodiments thereof will be shown and described below in detail. The disclosure is not limited to the specific embodiments disclosed, but instead includes all modifications, alternative constructions, and equivalents thereof.

### DETAILED DESCRIPTION

The present disclosure provides a system and method for coaching an operator of a machine. The disclosed system and method act to improve operator skill levels by providing real-time coaching during an operation of the machine performed by the operator. The system and method monitor the operator's performance, determine a type of operation being performed, compare actual real-time data to expected data according to an ideal operating method, and notify the operator in real-time how he or she is performing. For example, the system may generate immediate feedback, such as, without limitation, an alert or audio coaching for an action needing improvement, recognition of an action consistent with a proper technique, or a real-time view of a linkage of the machine with superimposed visual effects guiding the operator towards the proper technique. In addition, the system and method can store data collected during the operation for coaching at a later time. For example, after the operation is finished and an engine of the machine is idle, the system and method may provide further coaching based on the operator's monitored performance (e.g., via a simulation, a recorded video, a text, an automated demonstration onboard the machine, or an audio description).

Reference will now be made in detail to specific embodiments or features, examples of which are illustrated in the accompanying drawings. Generally, corresponding reference numbers will be used throughout the drawings to refer to the same or corresponding parts.

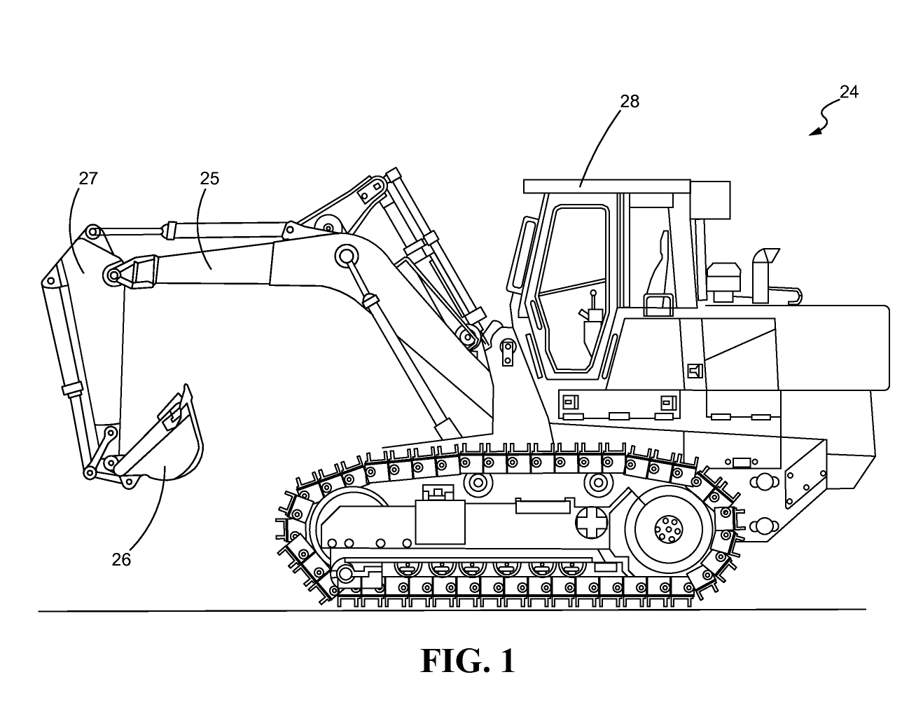

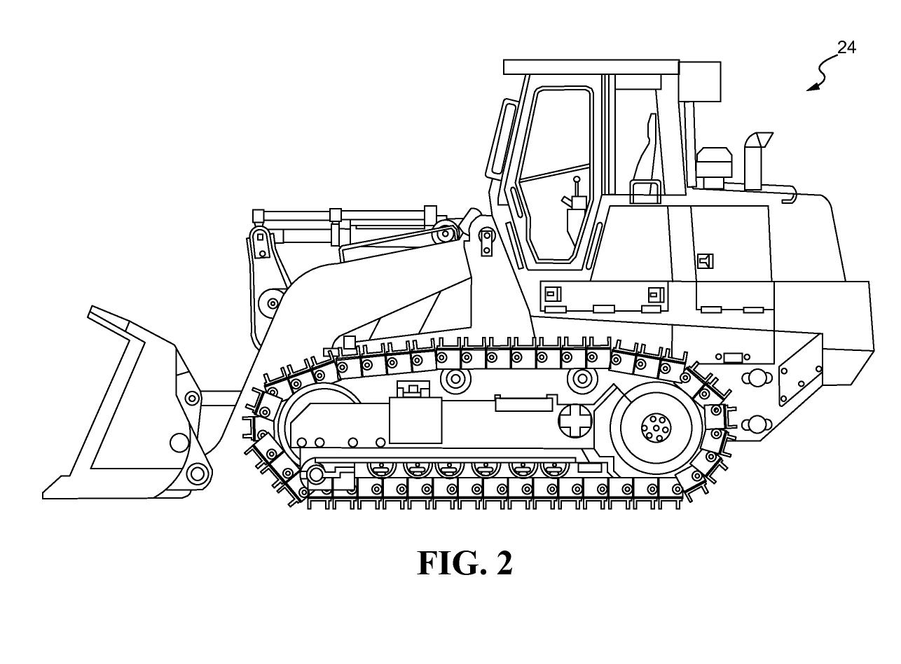

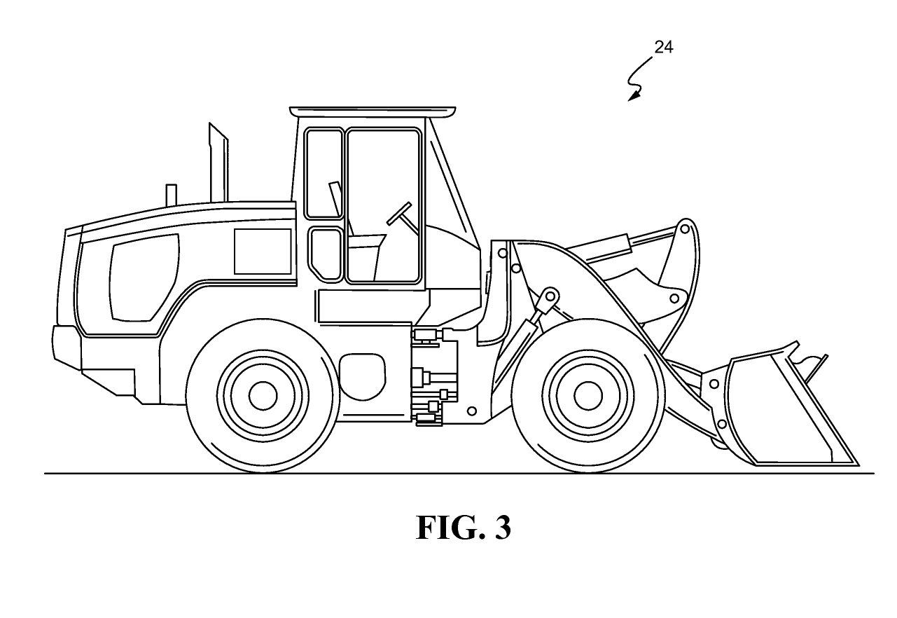

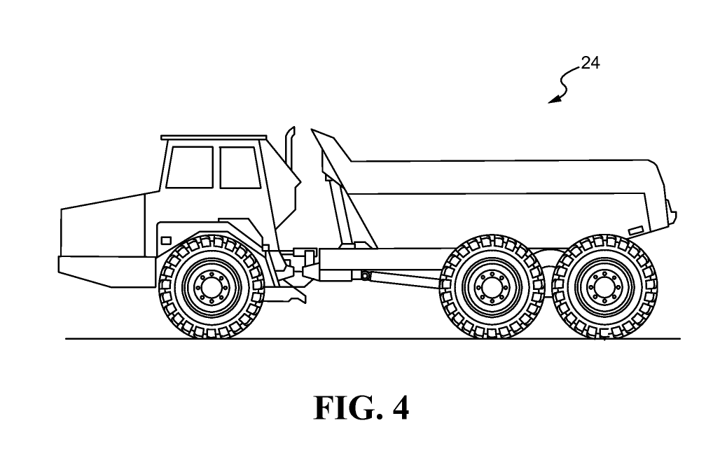

Turning now to FIGS. 1-8, although the machine 24 in FIG. 1 is shown to be an excavator, it will be understood that in other embodiments, the machine may be any other type of machine or vehicle, used in earthmoving, industrial or agricultural applications. For example, the machine 24 may be, without limitation, a tract-type tractor as shown in FIG. 2, a wheel loader as shown in FIG. 3, an articulated truck as shown in FIG. 4, a motor grader, a pipe layer, a backhoe, or the like. It is also to be understood that the machine 24 is shown primarily for illustrative purposes to assist in understanding the features of the various embodiments, but that FIG. 1 does not, and need not, depict all of the components of an exemplary machine.

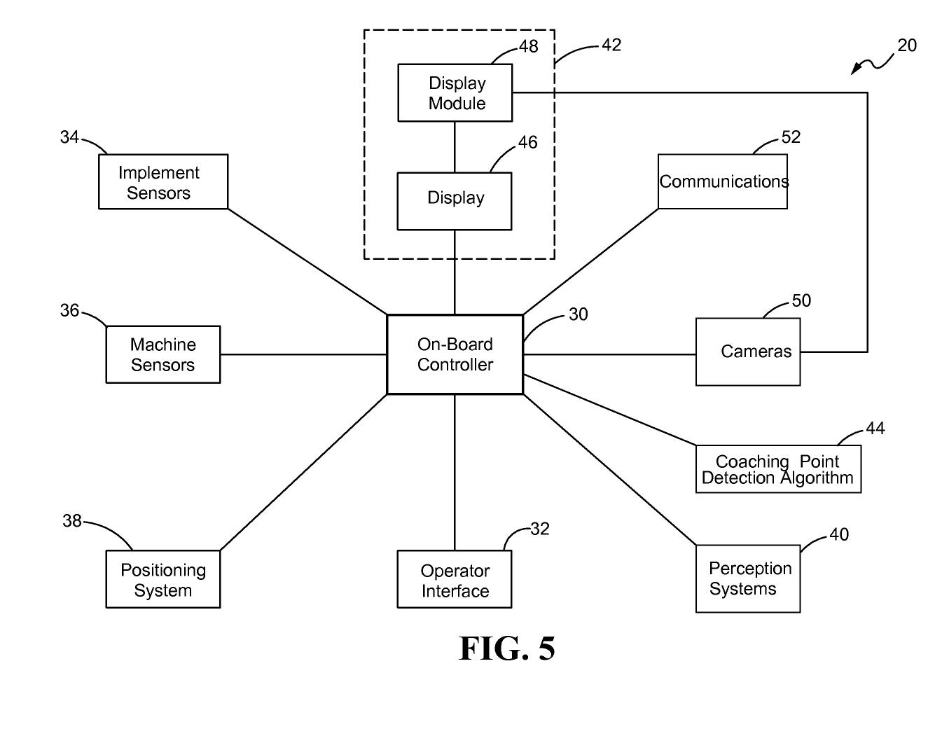

In an embodiment shown best in FIG. 5, the system 20 comprises a controller 30 in communication with an input device or operator interface 32, implement sensors 34, machine sensors 36, positioning system 38, perception systems 40, and output device 42, all of which may be on-board the machine 24. The controller 30 comprises any non-transitory computer readable medium having stored thereon computer-executable instructions, such as, at least one processor.

The controller 30 receives input from the operator through operator interface 32. Operator interface 32 may include one or more joysticks, steering wheels, pedals, keyboards, touchscreens, displays, or the like, for manipulation of the machine 24 by the operator. The implement sensors 36 may comprise sensors configured to measure implement or tool position, load pressure, pin angle, actuator displacement, and the like. The machine sensors 36 may comprise sensors configured to measure machine speed, engine speed, transmission gear, steering angle, articulation angle, and the like.

The positioning system 38 may identify a current location, time or position of the machine 24 and may comprise a navigation system which uses the global positioning system (GPS), an inertial measurement unit (IMU), a dead reckoning procedure, perception-based localization (PBL), or a combination thereof. The system 20 also comprises on-board and off-board perception systems 40, which may detect objects, personnel, or other machines close to the machine 24. The perception systems 40 may use radar, lidar, cameras, or a combination thereof for object and personnel detection. The output device 42 may include one or more displays, monitors, screens, touchscreens, lights, speakers, buzzers, or the like, for providing information from the system 20 to the operator.

Algorithms or sets of instructions for monitoring the operation of the machine 24 performed by the operator are preprogrammed into a memory of the controller 30. More specifically, the controller 30 may be programmed to determine a type of operation (e.g., a dig to dump cycle) being performed in real-time. Different types of operations, defined by a series of actions, may be programmed into the memory associated with the controller 30. The controller 30 analyzes the real-time data received from the operator interface 32, implement sensors 34, machine sensors 36, positioning system 38, and/or perception systems 40 in order to detect the type of operation the machine 24 is performing.

In an example where the machine 24 is an excavator, from signals sent by the positioning system 38 and perception systems 40, as well as from a site map stored in memory which includes various terrain or geographic features (e.g., a dig location, a dump location, etc.), the controller 30 may compare a location of the machine 24 to the site map in order to determine a position of the machine 24 relative to a dig location and a dump location. From signals sent by the machine sensors 36, the controller can determine that an engine of the machine 24 is idle. From signals sent by the operator interface 32, the controller 30 can determine commands indicative of digging material from the dig location with implement (e.g., bucket 26); commands indicative of lifting, swinging, and lowering linkages (e.g., boom 25 and stick 27) from the dig location to the dump location; commands indicative of dumping material to the dump location; and commands indicative of lifting, swinging and lowering linkages from the dump location back to the dig location. From signals sent by the implement sensors 34 (e.g., pressure sensor in the bucket 26), the controller can determine material being loaded into and dumped from the bucket 26. Based on a combination of this data, the controller 30 detects that the machine 24 going through a dig to dump cycle. The controller 30 can certainly detect other types of operations as well.

The controller 30 is also programmed to include, among other things, a coaching point detection algorithm 44. The coaching point detection algorithm 44 detects a coaching point, or a specific action to monitor during the operation. Expert operators and trainers may identify coaching points based on common practices of novice operators who need coaching to perform the specific action in an efficient or safe manner, or to achieve an optimal performance of the machine 24. For example, a coaching point for the excavator may be minimizing unnecessary linkage motion. To achieve an efficient performance of the machine 24, it may be optimal to limit the linkage movement during swing to dig and to dump. Therefore, when swinging from the dig location to the dump location (or vice versa), the operator may ideally keep an angle between boom 25 and stick 27 unchanged.

Other examples of coaching points for the excavator may include, without limitation, linkage position within an efficient range (e.g., stick 27 is within mechanical advantage parameters during dig, depth of a cut, and digging in layers), minimizing machine rocking on uneven ground during dig and swing (e.g., machine stability during dig and machine stability during swing), and not blowing the release for stick 27, bucket 26, boom 25, and swing. There may be a list of various coaching points, each coaching point having a detection algorithm to detect when the coaching point occurs during the operation. Thus, during the determined type of operation, the controller 30 may be checking for more than one coaching point.

In addition, coaching points may vary depending on the particular machine 24. For example, coaching points for the wheel loader (FIG. 3) may be, without limitation, no articulation during dig, setting tires properly, loading with lift using bucket curl, proper bucket angle during dig, and loading the bucket 26 without using back and forth articulation. One coaching point for the articulated truck (FIG. 4) may be improper positioning of the articulated truck relative to a load location, while a coaching point for a tract-type tractor (FIG. 2) may be using proper gears when dozing and push loading. Other coaching points are certainly possible.

Expected data for each coaching point, such as a predetermined set of parameters in accordance with an ideal operating method for the coaching point, may be included in the coaching point detection algorithm 44 preprogrammed into the memory associated with the controller 30. The controller 30 then compares actual real-time data sent from the operator interface 32, implement sensors 34, machine sensors 36, positioning system 38, and perception systems 40 during the operation to the expected data for the coaching point. Through output device 42, the controller 30 notifies the operator in real-time of his or her performance based on the comparison of the actual data to the expected data.

For example, if the actual data is not within (i.e., outside of) the expected data, then the operator is not performing according to the ideal operating method for the coaching point, and the controller 30 may detect a non-conforming or coachable action needing improvement. The controller 30 immediately provides coaching (e.g., an audio and/or visual notification) to the operator in real-time so that the operator may be informed of the coachable action or may be coached toward a proper technique. The notification may include, without limitation, a sound, a buzzer, an audio warning, an audio description for coaching the operator toward an expected or predetermined action in accordance with the expected data, a visual alert, a pop-up on a display, a light, and a combination thereof. If the actual data is within the expected data, then the operator is performing according to the ideal operating method for the coaching point, and the controller 30 may detect a conforming action. Similarly, the controller 30 may immediately provide coaching in real-time, such as, via an approbatory audio and/or visual notification to the operator for the conforming action.

For instance, in the coaching point example of minimizing unnecessary linkage motion during swing to dig and swing to dump, when the controller 30 determines that the machine 24 is going through a dig to dump cycle (as described above), the coaching point detection algorithm 44 monitors an angle change between the boom 25 and stick 27 during swing. The angle between the boom 25 and stick 27, or stick angle, may be detected by the implement sensors 34 (e.g., stick angle sensor). The change in stick angle is monitored from an initial stick angle (at either the dig location or dump location) to an increase or decrease in the detected stick angle during swing (to either the dump location or dig location). The controller 30 then compares the detected or actual change in stick angle to the expected change in stick angle during swing.

For example, since it may be optimal for the stick angle change when swinging (from the dig location to the dump location and from the dump location to the dig location) to be unchanged, the expected data for the stick angle change may be less than ten degrees (<10°) according to an ideal operating method for the machine 24. Other values for the expected stick angle change are certainly possible. If the actual stick angle change is outside the expected data, e.g., greater than ten degrees (>10°), then the operator did not perform according to the ideal operating method, and the controller may detect a coachable action, notifying the operator in real-time. If the stick angle change is within the expected data, e.g., greater than ten degrees (<10°), then the operator did perform according to the ideal operating method and the controller may detect a conforming action, notifying the operator in real-time.

According to another aspect, a real-time view of the machine 24 may be displayed on output device 42 based on the actual real-time data received by the controller 30. The controller 30 may be in communication with a display 46 (e.g., output device 42) and a display module 48. The display 46 may comprise a screen, touchscreen, monitor, or the like, for displaying the real-time view of the machine. The display module 48 comprises any non-transitory computer readable medium having stored thereon computer-executable instructions. The display module 48 may be part of the controller 30 or part of the display 46. Furthermore, the display 46 and display module 48 may or may not be part of the machine 24. The real-time view of the machine 24 may be displayed on a monitor within a cab 28 of the machine 24.

The display module 48 includes instructions for simulating the real-time view using computer graphics in 2D, 3D, wireframe, or the like. More specifically, the controller 30 may send to the display module 48 the actual real-time data related to operator commands, machine 24 or linkage position. The display module 48 generates a simulation of an actual action in real-time on the display 46 using the actual data received by the controller 30, as well as other preprogrammed data (e.g., machine dimensions, linkage or implement dimensions, operator control dimensions, site maps and the like) in the memory associated with the controller 30. For example, using actual data collected from the operator interface 32, implement sensors 34, machine sensors 36, positioning system 38, and perception systems 40 along with the preprogrammed data, a view of the machine 24 acting in its environment may be simulated and displayed in real-time. The controller 30 may access a site map stored in memory, which includes various terrain or geographic features (e.g., a position of the dig location, a position of the dump location, etc.), and may compare a location of the machine to the site map in order to detect the position of the machine 24 relative to its environment.

Other views, including but not limited a view of a linkage/implement (e.g., boom 25, stick 27, and bucket 26) of the machine 24, or a view of the operator controls in the cab 28 may also be simulated and displayed in real-time. Alternatively, views of the machine 24 relative to the worksite from the positioning system 38 may be used for display. Multiple views may be displayed at the same time. According to another aspect, the system 20 may include at least one camera 50 in communication with the controller 30, display 46, and/or display module 48 for displaying the actual view of the machine 24 in real-time. For example, the cameras 50 can be onboard the machine 24, such as in the cab 28 to capture manipulation of the operator interface 32 or out of the cab 28 to capture linkage or implement function and interaction with the worksite. The cameras 50 can also be off-board the machine 24 in order to capture a view of the entire machine 24 interacting with the worksite.

In addition, a relationship between the actual action in real-time and an expected action, or a predetermined action in accordance with the expected data and ideal operating method, can be displayed. According to this aspect, based on the actual data, the preprogrammed data (e.g., machine dimensions, linkage or implement dimensions, operator control dimensions, site maps, and the like), the expected data, and the comparison of actual data to expected data, signals indicative of the relationship between the actual data and the expected data are generated by the controller and sent to the display module 48 for output on display 46. In this aspect, the controller 30 and display module 32 display a view of the machine 24 in real-time together with simulated graphics coaching the operator toward the predetermined action in accordance with the predetermined set of parameters. The real-time view of the machine may be annotated or superimposed with simulated computer graphics including, but not limited to, arrows, numbers, words, colors, and the like.

According to one aspect, the relationship between the actual action in real-time and the expected action is displayed through a color scheme. For example, in a real-time view of a linkage of the machine 24, the display 46 may show a green color superimposed on the view of the linkage, if the actual data for a position, angle, etc. of the linkage is within the expected data. The display 46 may show a red color superimposed on the view of the linkage, if the actual data for the position, angle, etc. of the linkage is outside of the expected data. The colors on the display may change depending on whether the actual action is approaching toward or moving away from the expected action. The color scheme may guide the operator via the display 46 to performing the expected action.

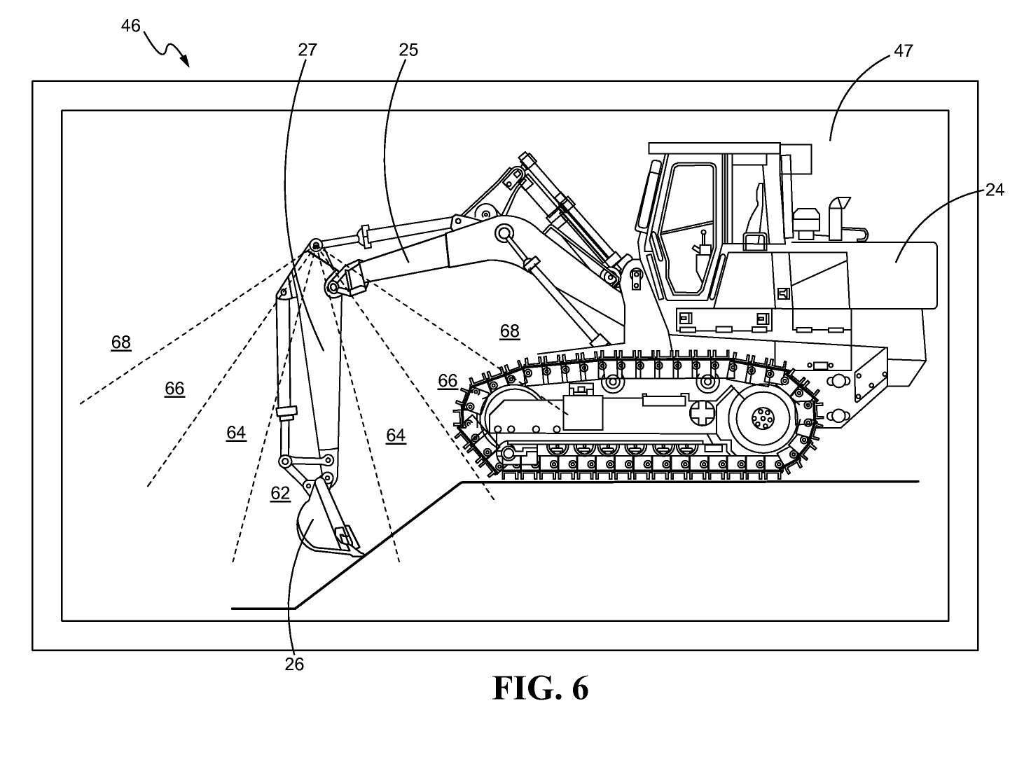

Furthermore, a gradient of colors ranging from green to red (e.g., green, yellow, orange, red) may be superimposed on the real-time view of the linkage to depict a magnitude of the relationship between the actual action and the predetermined action. For instance, as shown schematically in FIG. 6, in the coaching point example of minimizing unnecessary linkage motion during swing to dig and swing to dump, when the stick angle change is within the expected data (e.g., the stick angle change is less than ten degrees (<10°), or when the actual stick angle in real-time is within ten degrees (10°) of the initial stick angle at dig or dump), the controller 30 and display module 48 may show a green-colored zone 62 superimposed around the stick 27 of the machine 24 on a screen 47 of the display 46, indicating that the actual real-time action conforms to an expected action in accordance with the expected data. The green-colored zone 62 may be associated with the expected data, while a yellow-colored zone 64, an orange-colored zone 66, and a red-colored zone 68 may be simultaneously shown on the display 46 to indicate divergence from the expected data of the ideal operating method.

Furthermore, if the stick angle change increases outside the expected data represented by the green-colored zone 62, an audio and/or visual warning may be conveyed to the operator. For example, if the stick 27 moved into the red-colored zone 68, indicating that the stick angle change is considerably outside the expected data, then a message (e.g., “Warning: unnecessary linkage motion during swing!”) can be announced over speakers of the output device 42 and the red-colored zone 68 may start blinking on the display 46. In so doing, the operator may be coached to adjust the stick 27 such that it moves from the red-colored zone 68, through the orange-colored zone 66 and the yellow-colored zone 64 until it reaches the green-colored zone 68. Once the stick 27 is in the green-colored zone 68, the controller 30 may provide an approbatory audio message (e.g., “Good job!”) and/or visual message (e.g., via a pop-up on the display 46). It will be understood that other color schemes than that described, as well as other visual or audio effects, are certainly acceptable without departing from the scope of the present disclosure.

According to another aspect, in an enhanced tutorial mode, once the controller 30 determines the type of operation (e.g., dig to dump cycle) being performed on the machine 24, the controller 30 may present to the operator various options for receiving coaching information for the particular type of operation. The coaching information may include the list of coaching points (as described above), a list of suggested topics for training the operator to perform the operation using proper techniques (e.g., ideal operating methods in accordance with the expected data), and also a list of common errors to avoid. When the controller 30 detects the type of operation being performed, the controller 30 sends signals to the output device 42 for notifying the operator, in real-time, of the coaching information available for his or her use (e.g., via a pop-up on the display 46 or an audio message stating, “I think you are digging. Would you like help?”). The operator may then decide whether to access the coaching information immediately, at a later time, or not at all.

The coaching information may be provided to the operator through different forms of coaching, such as, including but not limited to, a simulation, a video, a text, an automated demonstration onboard the machine 24, an audio description, or a combination thereof. The simulation may include the computer graphics simulated view of the machine 24 described above, along with the color scheme representation of the relationship between the real-time action and the predetermined action, or a simulation of the operator's action synchronized and side-by-side with the predetermined action. The video may include a captured view of the machine 24 using the cameras 50, along with the color scheme described above, or a view of the machine synchronized and side-by-side with a recorded video of the predetermined action. The text may include written instructions on how to perform in accordance with predetermined actions, or may refer to a manual of operation specific to the machine 24. The automated demonstration onboard the machine 24 may allow the controller 30 to take over the machine 24 and autonomously perform an action or operation for the operator to observe. The audio description may describe the predetermined action or proper techniques for operation, or may also describe errors of the operator's performance, the effect of those errors and how to correct them. The combination of coaching forms may include the simulation synchronized with the audio description, the video synchronized with the audio description, the text shown on the display 46 while also communicated audibly through a speaker, the automated demonstration synchronized with the audio description, or the like. The audio description may be provided before, during, or after the simulation, video, text, or automated demonstration.

In one aspect, the controller 30 sends a signal to the output device 42 prompting the operator for input as to which form of coaching to provide the information. The operator can then personally select which coaching form to learn from. Alternatively, the controller 30 can determine which form to provide the coaching information to the operator. The coaching point detection algorithm 44 may include the coaching form to provide based on each coaching point, as preprogrammed into a memory associated with the controller 30. For instance, in the coaching point example for the tract-type tractor (FIG. 2) of using proper gears when dozing and push loading, an audio description or a text informing the operator which gear to use when the controller 30 determines that the tractor is dozing (or which gear to use when the controller 30 determines that the tractor is push loading) may be automatically provided to the operator, instead of, for example, an automated demonstration (or the option for an automated demonstration). In addition, the controller 30 may analyze the real-time data related to a detected coachable action or a type of operation being performed, as well as other real-time or preprogrammed data, in order to present the coaching information. For example, based on an amount of times the operator performs a specific type of operation, the controller 30 may present a specific coaching point or option to provide an automated demonstration of the detected type of operation.

According to another aspect, while monitoring the operator's performance, the controller 30 can flag and store in memory, the received data, time, simulations, captured videos, list of suggested topics, or any other information necessary for coaching the operator at a later time. Thus, the operator may review his performance, coaching points, notifications, coachable actions, conforming actions, coaching information, etc. when he is not manually operating the machine 24, such as, when the engine is idle, at an end of his shift, or at a beginning of his next performance. In addition, the system 20 includes communications systems 52, which connect to off-board components, such as through cellular, Wi-Fi, and other wired or wireless communication devices. The controller 30 then sends, via communications systems 52, data related to the operator's performance and coaching information to an off-board location, where the operator can further observe his actions compared to proper operating methods, or a manager of the operator can review the operator's performance.

Furthermore, the controller 30 may present the coaching information as a prioritized list of coaching points to the operator. In this aspect, if the controller 30 detects more than one coachable action needing improvement throughout the different coaching points (e.g., the operator did not perform according to the ideal operating methods or within the expected data for different coaching points), the controller 30 stores coaching information for each detected coachable action (e.g., data related to the actual actions of the operator and the expected actions in accordance with the expected data), and the controller 30 prioritizes the coaching points. The coaching point detection algorithm 44 includes a predetermined priority for the various coaching points, preprogrammed into the memory associated with the controller 30. The predetermined priority may be based on an order of importance of the coaching points as predetermined by trainers, managers, or experienced operators. The controller 30 also prioritizes the coaching information using the received real-time data during the operation. For example, a number of occurrences of a detected coachable action, a severity of the coachable action, machine productivity, and machine performance are other factors that the controller 30 uses to prioritize an order of importance for the coaching points.

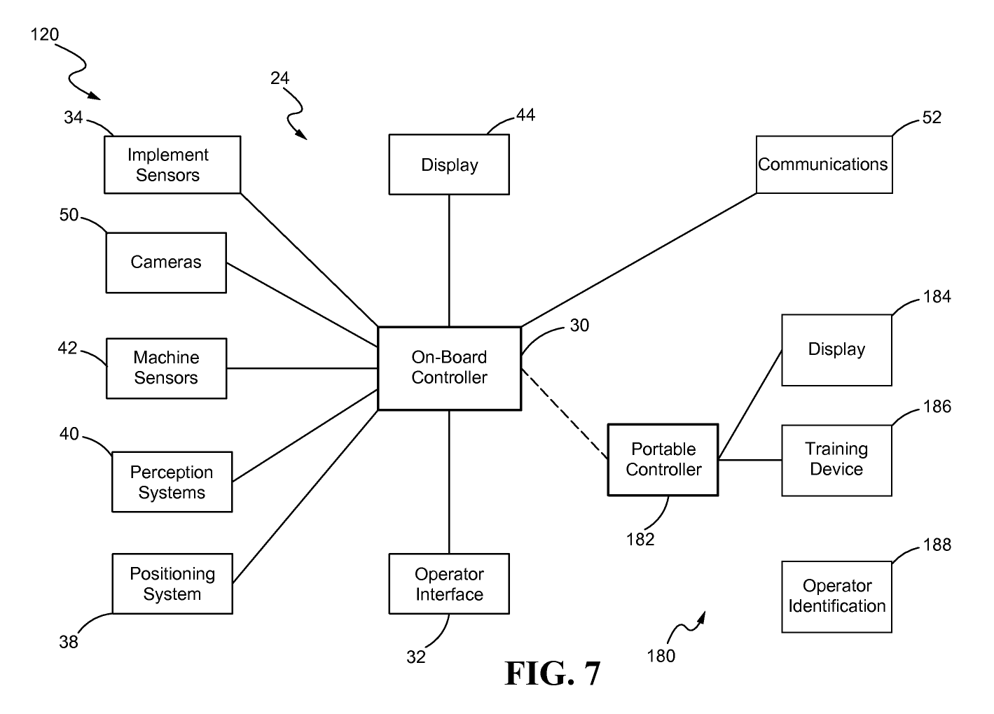

Referring now to FIG. 7, according to another embodiment of the present disclosure, the system 120 comprises a portable apparatus 180 that is not integral to the machine 24. The portable apparatus 180 includes a controller 182 in communication with a display 184, a training device 186 containing the coaching point detection algorithm, and an operator identification device 188 for the operator to identify himself and to allow tracking of individual progress, in this aspect. The controller 182 of the portable apparatus 180 may be operatively configured to communicate with the controller 30 of the machine 24. Algorithms or sets of instructions for monitoring operator performance, detecting types of operations being performed and coaching points, comparing actual real-time data to expected data, displaying real-time views, and providing coaching information may be preprogrammed into a memory of the controller 182, training device 186, or a display module of the display 184, as described above with the controller 30 and display module 48.

Thus, when connected to the machine 24, the controller 182 of the portable apparatus 180 uses and collects data from the controller 30 and other parts (e.g., operator interface 32, implement sensors 34, machine sensors 36, positioning system 38, perception systems 40, and cameras 50) of the machine 24 in order to monitor an operation of the machine and provide coaching to the operator in real-time. The other features described above with regard to the system 20 and controller 30 may also be incorporated into the portable apparatus 180.

### INDUSTRIAL APPLICABILITY

In general, the foregoing disclosure finds utility in various industrial applications, such as in earthmoving, industrial, construction and agricultural machines. In particular, the disclosed operator coaching system and method may be applied to excavators, wheel loaders, tract-type tractors, motor graders, articulated trucks, pipe layers, backhoes, and the like. By applying the disclosed system and method to a machine, the operator's performance may be monitored and real-time coaching may be provided based on the operator's performance. For example, the controller of the system can detect coachable actions needing improvement, as well as conforming actions in accordance with predetermined proper operating methods, and notify the operator in real-time of his coachable and/or conforming actions.

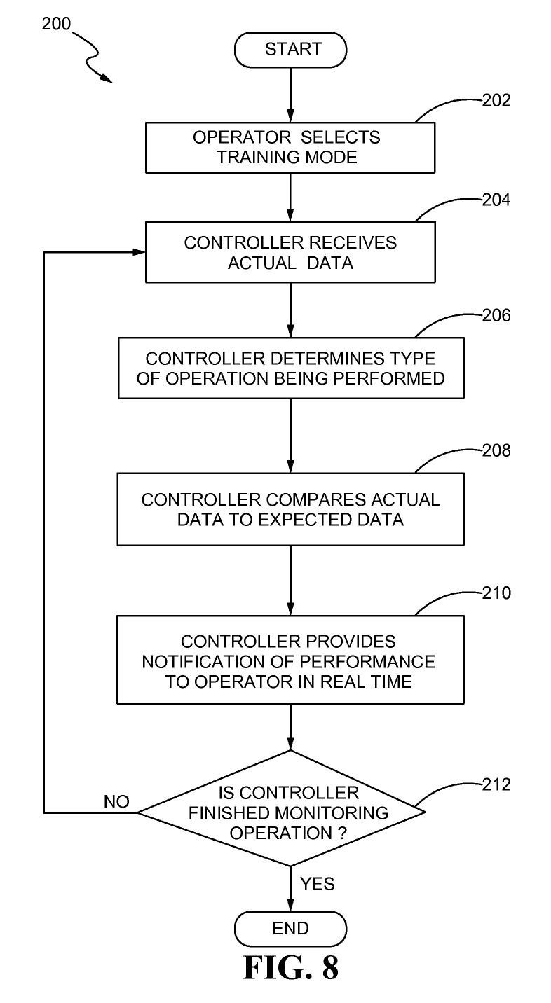

Turning now to FIG. 8, a flowchart outlining the method 200 for coaching the operator of the machine is shown, according to another embodiment of the present disclosure. At a first step 202 of the method 200, the operator selects input (via the I/O device) to put the machine in a training mode. When the controller receives input to enable the training mode, the controller starts monitoring the operator's performance. At a next step 204, the controller receives actual real-time data related to an operation of the machine performed by the operator. For example, in order to monitor the operation, data may be received from operator interface, implement sensors, machine sensors, positioning system, and perception systems during the operation. At a next step 206, the controller determines a type of operation being performed based on the actual data. Next, at a step 208, the controller compares the actual data to expected data for the operation, as preprogrammed into a memory associated with the controller. For example, if the actual data is outside of the expected data, the controller detects a coachable action not conforming to the expected data according to the ideal operating method for the determined type of operation; and if the actual data is within the expected data, the controller detects a conforming action.

At a next step 210, the controller provides notification to the operator of his or her performance in real-time based on the comparison of the actual data to the expected data. For example, the controller may warn the operator of a detected coachable action or may commend the operator of a detected conforming action through the output device. Lastly, at a step 212, the controller determines whether it is finished monitoring the operation. If it is finished monitoring the operation, then the method 200 is at an end. If the controller is not finished monitoring the operation, then the method 200 repeats again at step 204. The controller may be continuously monitoring the operation and collecting data throughout the operation and steps of the method 200.

In an example where the machine is a wheel loader, as shown in FIG. 3, at the first step 202, the operator selects to go into training mode on the machine. At the next step 204, the controller receives actual data from the operator interface, implement sensors, machine sensors, positioning system, and perception systems. At the next step 206, based on the actual data, the controller can determine the type of operation being performed, such as digging. For example, from signals sent by the perception systems, the controller can determine that the wheel loader is approaching a pile of material. From the stored site map and signals sent by the positioning system, the controller can determine a GPS location of the wheel loader relative to the pile. From signals sent by the operator interface, the controller can determine commands to lift a linkage and the bucket. From signals sent by the implement sensors (e.g., pressure sensor in the bucket), the controller can determine that material is being loaded into the bucket; and from signals sent by the machine sensors, the controller can determine an engine speed and transmission gear. Based on a combination of this data, the controller detects that the wheel loader is digging.

At the next step 208, once the controller determines that the wheel loader is digging, the controller compares actual data to expected data for digging. For example, the controller can check for various coaching points related to digging and compare actual data to expected data.

For instance, one example of a coaching point the controller can check for when digging is being done is excessive articulation. Wheel loaders generally steer via articulation, which includes a pair of hydraulic cylinders connected between a front frame and a rear frame on opposing sides of an articulation point. Each cylinder may be selectively actuated (e.g., extended and retracted) to pivot the front frame with respect to the rear frame and steer the wheel loader. To achieve an efficient performance of the machine, it may be optimal for the machine 24 to enter the pile straight on, not articulated.

When the controller determines that the wheel loader is digging, the coaching point detection algorithm monitors the articulation angle of the wheel loader. The articulation angle may be detected by the machine sensors (e.g., cylinder position sensor or articulation joint sensor) and sent to the controller. The coaching point detection algorithm then compares the detected or actual articulation angle to expected data for the articulation angle while digging. For example, since it may be optimal for the machine to enter the pile straight on, the expected data for the articulation angle while digging may be between negative fourteen degrees (−14°) and fourteen degrees (14°), according to an ideal operating method for the wheel loader. Other values for the expected data parameters for the articulation angle are certainly possible.

Next, at the step 210, the controller provides notification of performance to the operator in real-time based on the comparison of actual data to expected data. If the actual articulation angle is outside the expected data, e.g., greater than fourteen degrees (14°) or less than negative fourteen degrees (−14°), then the operator did not perform according to the ideal operating method and the controller can send a warning to the operator in real-time. Furthermore, the controller and display module may show a top view of the wheel loader relative to the pile in real-time with superimposed graphics for a correlation to expected data, e.g., a color scheme representing a relationship between the actual articulation angle and expected articulation angle or arrows guiding the operator to an articulation angle between negative fourteen degrees (−14°) and fourteen degrees (14°). If the actual articulation angle is within the expected data, e.g., between negative fourteen degrees (−14°) and fourteen degrees (14°), then the operator did perform according to the ideal operating method and the controller may send an approbatory message to the operator in real-time. Lastly, at the step 212, the controller determines whether it is finished monitoring the operation.

In another example where the machine is an articulated truck, as shown in FIG. 4, at the first step 202, the operator selects to go into training mode. At the next step 204, the controller receives actual data from the operator interface, implement sensors, machine sensors, positioning system, and perception systems. At the next step 206, based on the actual data received, the controller can determine the type of operation being performed, such as carrying and dumping a payload. For example, from signals sent by the implement sensors (e.g., payload weight sensor in the dump body), the controller can determine there is a payload in the dump body. From signals sent by the operator interface, the controller can determine commands to reverse the truck, stop the truck, and lift the dump body. From signals sent by the machine sensors, the controller can determine an engine speed and transmission gear. From signals sent by the perception systems, the controller can detect the dump location (e.g., a cliff or wall of the dump location). From the stored site map and signals sent by the positioning system, the controller can determine a GPS location of the truck relative to the dump location. Based on a combination of this data, the controller detects that the truck is carrying and dumping the payload onto the dump location.

At the next step 208, once the controller determines that the dump truck is carrying and dumping the payload onto the dump location, the controller compares actual data to expected data for carrying and dumping. For example, the controller can check for various coaching points related and compare actual data to expected data. One example of a coaching point the controller can check for when carrying and dumping the payload is improper positioning of the truck relative to the dump location. Expected data for an optimal positioning of the truck to the dump location may be about five meters (5 m) to eight meters (8 m) from a back edge of the truck to the wall of the dump location. Other distances and configurations are certainly possible. The controller detects the actual distance from the back edge of the truck to the wall (via the stored site map, positioning system, and/or perception system) when an engine of the truck is idle (via signals for machine speed or transmission gear from the machine sensors) and the operator inputs the command to lift the dump body (via signals from the operator interface). The controller then compares the actual distance when dumping to the expected distance

Next, at the step 210, the controller provides notification of performance to the operator in real-time based on the comparison of actual distance to expected distance. If the actual distance between the back edge of the truck and the wall of the dump location is less than five meters (5 m) or greater than eight meters (8 m), then the controller can warn the operator that he or she is not performing according to the ideal operating method, e.g., an audio or visual message that the operator is too close or too far from the dump location and instructions to the operator for moving the truck a certain distance and direction to achieve the optimal positioning. Furthermore, the controller and display module may show a top view of the truck relative to the dump location, or an enlarged side view of the back edge of the truck relative to the wall of the dump location, in real-time with superimposed graphics for a correlation to expected data, e.g., a color scheme representing a relationship between the actual distance and expected distance or arrows guiding the operator to a distance of five to eight meters (5-8 m) between the back edge and wall. If the actual distance is within five to eight meters (5-8 m), then the controller may send an approbatory message to the operator in real-time. Lastly, at the step 212, the controller determines whether it is finished monitoring the operation.

It will be understood that the flowchart in FIG. 8 is shown and described as an example only to assist in disclosing the features of the system and that more or fewer steps than shown, in a same or different order, may be included in the method corresponding to the various features described above for the disclosed system without departing from the scope of the present disclosure.

Other innovative coaching and training features are also disclosed. For example, coaching information (e.g., a list of coaching points) may be presented to the operator when the type of operation being performed is detected by the operator. Furthermore, the coaching information may be presented in the form of a simulation, a video, a text, an automated demonstration onboard the machine, an audio description, or a combination thereof. Moreover, a real-time view of a linkage of the machine can be displayed along with visual feedback for coaching the operator toward a proper technique. The system also prioritizes a list of coaching points for review by the operator in an order of importance and can decide which form of coaching is best suited for which coaching point.

While the foregoing detailed description has been given and provided with respect to certain specific embodiments, it is to be understood that the scope of the disclosure should not be limited to such embodiments, but that the same are provided simply for enablement and best mode purposes. The breadth and spirit of the present disclosure is broader than the embodiments specifically disclosed and encompassed within the claims appended hereto.

While some features are described in conjunction with certain specific embodiments, these features are not limited to use with only the embodiment with which they are described, but instead may be used together with or separate from, other features disclosed in conjunction with alternate embodiments.

What is claimed is:

1. A method for coaching an operator of a machine having a controller in communication with a plurality of sensors configured to generate actual data indicative of real-time parameters associated with an operation of the machine, the method comprising:
the controller receiving actual data related to the operation of the machine performed by the operator;
the controller determining a type of operation being performed based on the actual data;
the controller comparing the actual data to expected data for the type of operation being performed as preprogrammed in a memory associated with the controller; and
the controller providing notification of performance to the operator in real-time based on the comparison of the actual data to expected data.

2. The method of claim 1, further comprising the controller detecting a coachable action if the actual data is outside of the expected data.

3. The method of claim 2, wherein the notification of performance to the operator is in a form of at least one of a sound, a buzzer, an audio warning, an audio description, a visual alert, a display, and a light.

4. The method of claim 2, further comprising the controller detecting more than one coachable action, the controller storing data related to the coachable actions, the controller prioritizing the coachable actions into a list, and the controller sending a signal to display the prioritized list of coachable actions to the operator.

5. The method of claim 1, further comprising the controller detecting an action conforming to the expected data, and wherein the controller provides an approbatory message to the operator of the conforming action in real-time.

6. The method of claim 1, further comprising the controller sending a signal to display an actual view of the machine in real-time.

7. The method of claim 6, wherein the actual view of the machine includes a computer-simulated real-time view of a linkage of the machine based on the actual data.

8. The method of claim 7, further comprising the controller sending a signal to display a relationship between the actual view of the machine and an expected action in accordance with the expected data.

9. The method of claim 8, wherein the relationship is displayed in a color scheme.

10. The method of claim 9, wherein the color scheme is a color gradient ranging from a green-colored zone to a red-colored zone depending on a magnitude of the relationship, the green-colored zone being associated with the expected data, and the red-colored zone being associated with divergence from the expected data.

11. The method of claim 1, further comprising the controller storing data related to the operation for coaching at a later time.

12. The method of claim 1, further comprising the controller providing coaching information to the operator in a form of at least one of a simulation, a video, a text, an automated demonstration onboard the machine, and an audio description.

13. The method of claim 12, further comprising the controller determining which form to provide the coaching information to the operator.

14. A system for coaching an operator of an earthmoving machine, comprising:
a plurality of sensors configured to generate signals indicative of actual data associated with an operation of the machine performed by the operator in real-time;
a controller in communication with the plurality of sensors, the controller configured to:
receive the signals indicative of actual data associated with the operation,
compare the actual data to expected data preprogrammed into a memory associated with the controller, and
notify the operator of his performance in real-time based on the comparison of the actual data to the expected data; and
an output device in communication with the controller, the output device configured to output notification from the controller of operator performance in real-time.

15. The system of claim 14, further comprising a display module in communication with the controller and the output device, the display module configured to display a real-time view of a linkage of the machine on the output device.

16. The system of claim 15, wherein the display module is further configured to use computer graphics to display the real-time view based on the actual data.

17. The system of claim 14, further comprising an input device in communication with the controller and configured to generate signals indicative of input received from the operator, and wherein the controller is further configured to receive the signals indicative of input received from the operator, and determine a type of operation being performed based at least in part on the signals received from the plurality of sensors and the input device.

18. The system of claim 14, wherein the controller is further configured to provide coaching information to the operator in order to guide his performance to expected actions in accordance with the expected data.

19. A non-transitory computer-readable storage medium having stored thereon computer-executable instructions which when executed by a computer coach an operator of a machine, the computer-executable instructions comprising instructions for:
monitoring an operation of the machine performed by the operator;
determining a type of operation being performed;
comparing actual data from the operation in real-time to expected data for the determined type of operation; and
generating feedback to the operator in real-time of his performance based on the comparison of the actual data to expected data.

20. The non-transitory computer readable storage medium of claim 18, further comprising instructions for storing data related to the comparison of the actual data to expected data for feedback to the operator at a later predetermined time.
